(19) United States
(12) Patent Application Publication
(10) Pub. No.: US 2025/0199595 A1
(43) Pub. Date: Jun. 19, 2025

(54) SYSTEMS AND METHODS FOR IMPLEMENTATION POWER OVER ETHERNET

(71) Applicant: DISH Network Technologies India Private Limited, Bangalore (IN)

(72) Inventors: Praveen Kumar G, Mangalore (IN); Vikram Balaraja Shetty, Bengaluru (IN); Srinidhi AN, Shivamogga (IN); Sendhil Kumar KB, Tamilnadu (IN)

(21) Appl. No.: 18/542,115

(22) Filed: Dec. 15, 2023

(51) Int. Cl. G06F 1/26

(52) U.S. Cl. CPC G06F 1/266

(57) ABSTRACT

Systems and methods are provided for implementing power over ethernet (“PoE”). One system includes a network interface card (“NIC”) including a first power jack configured to establish a first power connection with a power adapter. The NIC may include a first data port configured to establish a first communication link with a first external device, the first communication link enabling an exchange of data and sourcing of power with the first external device. The NIC may include a second data port configured to establish a second communication link with a second external device. The NIC may include a second power jack configured to establish a second power connection between the NIC and the second external device. The NIC may include a switching circuit configured to control sourcing of power by switching open or closed based on a source of the power.

### BACKGROUND

This disclosure relates to communication networks, including communication networks implementing power over ethernet (“PoE”). PoE generally refers to technology or techniques for delivering power with data on Ethernet cabling. PoE enables a single cable to provide both a data connection and a power connection that may power networked devices.

The discussion above is merely provided for general background information and is not intended to be used as an aid in determining the scope of the claimed subject matter.

### SUMMARY

This disclosure is in the field of communication networks, and more particularly, in the field of implementing PoE within communication networks.

Implementation of PoE generally involves power sourcing equipment (“PSE”) and a powered device (“PD”). PSE may include a device that provides (or sources) power on an Ethernet cable. An example of PSE may include a network switch. A PD may include a device powered by PoE. Examples of a PD may include a wireless access point (“WAP”), a voice over internet protocol (“VoIP”) phone, an internet protocol (“IP”) camera, etc. In some approaches, the PSE and the PD each have separate and distinct data ports (e.g., an RJ45) or Ethernet transformers. For instance, the PSE may include an RJ45 or an Ethernet transformer and the PD may include another RJ45 or another Ethernet transformer.

Accordingly, the technology disclosed herein may simplify implementation of PoE in a communication network. One configuration may provide a system for providing power over Ethernet (PoE). The system may include a network interface card (NIC). The NIC may include a first powerjack configured to establish a first power connection with a power adapter. The NIC may include a first data port configured to establish a first communication link between the NIC and a first external device, where the first communication link enables an exchange of data and sourcing of power with the first external device. The NIC may include a second data port configured to establish a second communication link between the NIC and a second external device, where the second communication link enables an exchange of data with the second external device. The NIC may include a second power jack configured to establish a second power connection between the NIC and the second external device, where the second power jack is configured to provide power to the second external device. The NIC may include a first switching circuit communicatively coupled to the first data port and the second power jack, wherein the first switching circuit includes a first switch and is configured to control sourcing of power to the second external device by opening or closing the first switch based on a source of the power, where the first switch is closed responsive to power received at the first data port, and where the first switch is opened responsive to power received at the first power jack.

Another configuration may provide a network interface card (NIC) for providing power over Ethernet (PoE). The NIC may include a first power jack configured to establish a first power connection with a power adapter. The NIC may include a first data port configured to establish a first communication link between the NIC and a first external device, where the first communication link enables an exchange of data and sourcing of power. The NIC may include a second data port configured to establish a second communication link between the NIC and a second external device, where the second communication link enables exchange of data with the second external device. The NIC may include a second power jack configured to establish a second power connection between the NIC and the second external device, where the second power jack is configured to provide power to the second external device. The NIC may include a power sourcing equipment (PSE) chipset configured to merge data and power signals. The NIC may include a powered device (PD) chipset configured to convert power received at the first power jack from a first DC power signal to a second DC power signal, where the first DC power signal is greater than the second DC power signal. The NIC may include a first switching circuit configured to control sourcing of power, and wherein, when the first power jack receives power, a first switch of the first switching circuit is opened, and wherein, when the first data port receives power, the first switch of the first switching circuit is closed to source the power received at the first data port to the second external device.

Yet another configuration may provide a method for providing power over Ethernet (PoE). The method may include establishing, via a first power jack of a network interface card (NIC), a first power connection with a power adapter. The method may include establishing, via a first data port of the NIC, a first communication link between the NIC and a first external device, where the first communication link enables an exchange of data and sourcing of power. The method may include controlling, via a first switching circuit of the NIC, sourcing of power based on a source of power by: opening a first switch included in the first switching circuit responsive to power being received at the first power jack to inhibit the power being received at the first power jack from flowing to a PD chipset of the NIC; and closing the first switch included in the first switching circuit responsive to power being received at the first data port to enable the power being received at the first data port to flow to the PD chipset of the NIC.

This Summary and the Abstract are provided to introduce a selection of concepts in a simplified form that are further described below in the Detailed Description. The Summary and the Abstract are not intended to identify key features or essential features of the claimed subject matter, nor are they intended to be used as an aid in determining the scope of the claimed subject matter.

### BRIEF DESCRIPTION OF THE DRAWINGS

The following drawings are provided to help illustrate various features of examples of the disclosure and are not intended to limit the scope of the disclosure or exclude alternative implementations.

FIG. 1 schematically illustrates a network interface card according to some configurations.

FIG. 2 schematically illustrates the network interface card of FIG. 1 electrically coupled to a power adapter and an external device in accordance with some configurations.

FIG. 3 schematically illustrates the network interface card of FIG. 1 electrically coupled to a power adapter and two external devices in accordance with some configurations.

FIG. 4 schematically illustrates the network interface card of FIG. 1 electrically coupled to two external devices in accordance with some configurations.

FIG. 5 schematically illustrates a circuit diagram of the network interface card of FIG. 1 in accordance with some configurations.

FIG. 6 schematically illustrates another circuit diagram of the network interface card of FIG. 1 in accordance with some configurations.

FIG. 7 schematically illustrates yet another circuit diagram of the network interface card of FIG. 1 in accordance with some configurations.

FIG. 8 is a flow chart illustrating a method of implementing PoE using the network interface card of FIG. 1 in accordance with some configurations.

### DETAILED DESCRIPTION OF THE PRESENT DISCLOSURE

The disclosed technology is not limited in its application to the details of construction and the arrangement of components set forth in the following description or illustrated in the following drawings. Other examples of the disclosed technology are possible and examples described and/or illustrated here are capable of being practiced or of being carried out in various ways. The terminology in this document is used for the purpose of description and should not be regarded as limiting. Words such as “including,” “comprising,” and “having” and variations thereof as used herein are meant to encompass the items listed thereafter, equivalents thereof, as well as additional items.

A plurality of hardware and software-based devices, as well as a plurality of different structural components can be used to implement the disclosed technology. In addition, examples of the disclosed technology can include hardware, software, and electronic components or modules that, for purposes of discussion, can be illustrated and described as if the majority of the components were implemented solely in hardware. However, in at least one example, the electronic based aspects of the disclosed technology (e.g., performing control or determination actions) can be implemented in software (for example, stored on non-transitory computer-readable medium) executable by one or more electronic processors. Although certain drawings illustrate hardware and software located within particular devices, these depictions are for illustrative purposes only. In some examples, the illustrated components can be combined or divided into separate software, firmware, hardware, or combinations thereof. As one example, instead of being located within and performed by a single electronic processor, logic and processing can be distributed among multiple electronic processors. Regardless of how they are combined or divided, hardware and software components can be located on the same computing device or can be distributed among different computing devices connected by one or more networks or other suitable communication links.

As noted herein, this disclosure is in the field of communication networks, and more particularly, in the field of implementing PoE within communication networks. Implementation of PoE generally involves power sourcing equipment (“PSE”) and a powered device (“PD”). PSE may include a device that provides (or sources) power on an Ethernet cable. An example of PSE may include a network switch. A PD may include a device powered by PoE. Examples of a PD may include a wireless access point (“WAP”), a voice over internet protocol (“VoIP”) phone, an internet protocol (“IP”) camera, etc.

In some PoE approaches, the PSE and the PD are separate devices that each have separate and distinct housings, circuit boards, and/or data ports (e.g., an RJ45) or Ethernet transformers. For instance, the PSE may include an RJ45 or an Ethernet transformer in a first housing and the PD may include another RJ45 or another Ethernet transformer in a second housing. The PSE may be coupled to the PD via an Ethernet cable to provide power to the PD, and the PSE and PD may communicate with one another via the Ethernet cable as well. According to the present disclosure, implementation of PoE may be simplified by implementing a network interface card (e.g., as a daughter card) that incorporates both PSE functionality and PD functionality. Such implementations may be configured to operate in a PSE mode or a PD mode. The PSE and PD functionality may share at least some hardware, for example, an Ethernet port that may be used to supply power over an Ethernet connection or receive power over an Ethernet connection, depending on the mode of operation.

Accordingly, in some configurations, the technology disclosed herein provides for a combined device (e.g., a network interface card, or daughter card) that shares an RJ45 and an Ethernet transformer (as opposed to separate devices with separate RJ45s and Ethernet transformers), as described in greater detail herein.

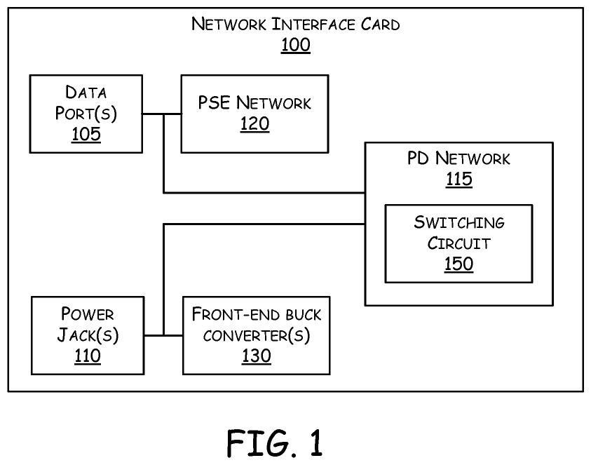

FIG. 1 illustrates an example network interface card (“NIC”) 100 according to some configurations. The NIC 100 may be a piece of computer hardware designed to enable communication between devices over a computer network. Accordingly, the NIC 100 may provide network connectivity between networked devices. In some instances, the NIC 100 may be considered a daughter card (or network daughter card) that connects to and augments functionality of one or more networked devices. For example, the NIC 100 may be a network daughter card included in, e.g., a networked device to improve network connectivity. Accordingly, the NIC 100 may be used to facilitate network connectivity between one or more networked devices (also referred to herein as external device(s)).

In the example illustrated in FIG. 1, the NIC 100 may include one or more data ports 105, one or more power jacks, a PD network 115, a PSE network 120, and one or more front-end buck converters 130. In some examples, the NIC 100 of FIG. 1 can include fewer, additional, or different components in different configurations than illustrated in FIG. 1. For instance, in some configurations, the NIC 100 may include additional or fewer data ports, power jacks, etc. As one example, the NIC 100 may include a single data port or multiple data ports (e.g., a first data port, a second data port, etc.). As another example, the NIC 100 may include a single power jack or multiple power jacks (e.g., a first power jack, a second power jack, etc.). As another example, the NIC 100 may include additional, fewer, or different networks than illustrated in FIG. 1. As yet another example, one or more components of the NIC 100 can be combined into a single device, divided among multiple devices, or a combination thereof. As one example, in some configurations, the front-end buck converter 130 may be included in the PSE network 120, the PD network 115, or a combination thereof.

The data port(s) 105 may establish a communication link between the NIC 100 and an external device, such as, e.g., a PSE, a PD, etc. The communication link between the NIC 100 and the external device may be established when the data port 105 receives a data connector or plug of a communication cable, where the communication cable is also connected to the external device. In some instances, the communication link is established using an Ethernet cable. In such instances, the data port 105 may receive an Ethernet connector or plug of an Ethernet cable. In some configurations, the data port 105 may be a registered jack 45 (“RJ45”) style data port, where the Ethernet cable may be an RJ45 cable.

In some configurations, the communication link may enable the exchange of data between the NIC 100 and the external device, as described in greater detail herein. In some examples, the communication link may enable the exchange of data from the NIC 100 to the external device or the exchange of data from the external device to the NIC 100. Alternatively, or in addition, in some configurations, the communication link may enable the sourcing of power between the NIC 100 and an external device. In some examples, the communication link may enable the sourcing of power from the NIC 100 to the external device or the sourcing of power from the external device to the NIC 100. Accordingly, in some configurations, the communication link may enable both the exchange of data and the sourcing of power between the NIC 100 and an external device. In some instances, the communication link may enable the exchange of data and the sourcing of power simultaneously between the NIC 100 and an external device.

In some configurations, the data port 105 may include (or otherwise be associated with or coupled to) an Ethernet transformer. In some configurations, the Ethernet transformer may split an input signal or signals into data signal(s) and power signal(s). For instance, when signals are received at the data port 105, the Ethernet transformer may split the received signals into data signals and power signals. Alternatively, or in addition, in some configurations, the data port 105 may include (or otherwise be associated with or coupled to) a PoE splitter, which may similarly split an input signal or signals into data signal(s) and power signal(s).

The power jack(s) 110 may establish a power connection between the NIC 100 and an external device, a power adapter, etc. The power connection may enable the exchange (or sourcing of) power between the NIC 100 and an external device, a power adapter, etc. As such, the power jack 110 may receive, via the power connection, power (e.g., a power signal) from, e.g., an external device, a power adapter, etc. Alternatively, or in addition, the power jack 110 may provide (or source), via the power connection, power (e.g., a power signal) to, e.g., an external device. As one example, the power jack 110 may establish a power connection between the NIC 100 and a power adapter such that the power adapter may provide, via the power connection, power to the NIC 100 with the power jack 110. Accordingly, in some configurations, the power jack 110 may operate as a PSE power jack, where the power jack 110 receives power from, e.g., a power connector or adapter. In other configurations, the power jack 110 may operate as a PD power jack, where the power jack 110 provides (or sources) power to, e.g., an external device (e.g., a PD).

The front-end buck converter(s) 130 may be a buck converter or step-down converter, such as, e.g., a DC-to-DC converter. In some configurations, the front-end buck converter 130 may adjust power (e.g., a power signal). For instance, the front-end buck converter 130 may decrease voltage while increasing current. In some configurations, the front-end buck converter 130 may interface with a power supply, such as, e.g., a power adapter coupled to the power jack 110.

As noted herein, the NIC 100 may provide functionality associated with PSE and a PD. For instance, the NIC 100 may function as both a PSE and a PD (e.g., in a PSE mode and a PD mode). Accordingly, as illustrated in FIG. 1, the NIC 100 includes the PD network 115 and the PSE network 120. The PD network 115 and the PSE network 120 may include one or more components specific to the functionality associated with a PSE and a PD, respectively, as described in greater detail herein. For instance, the PD network 115 may include a PD chipset (or PD controller) for executing functionality associated with a PD. Similarly, the PSE network 120 may include a PSE chipset (or PSE controller) for executing functionality associated with a PSE. In some configurations, the PD network 115, the PSE network 120, or a combination thereof may function as (or include) a voltage converter, as described in greater detail herein. Alternatively, or in addition, in some configurations, the PD network 115, the PSE network 120, or a combination thereof may include a diode bridge(s), such as, e.g., a bridge rectifier for converting alternating current (AC) to direct current (DC), as described in greater detail herein.

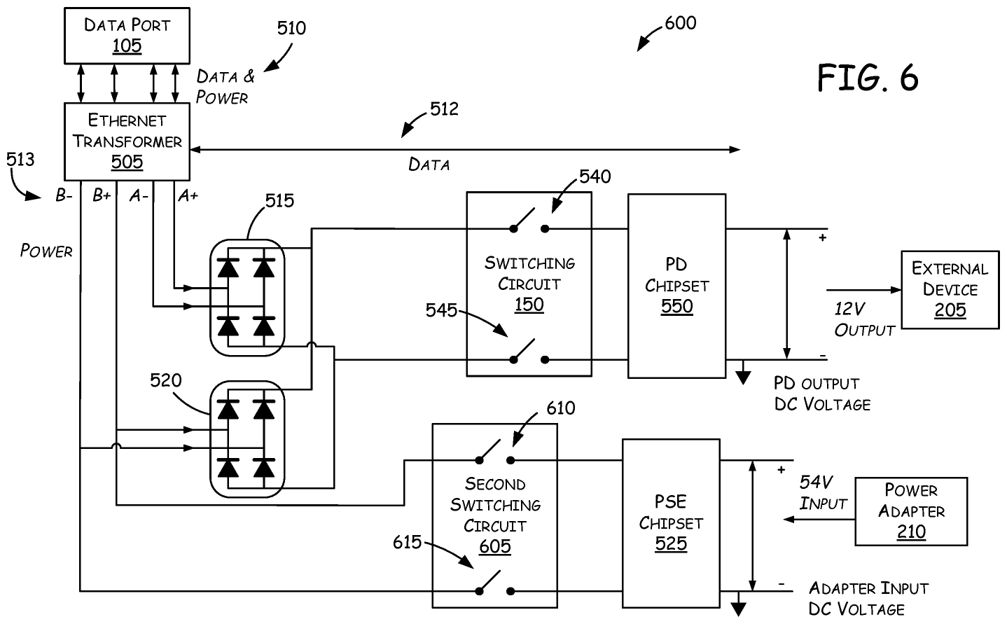

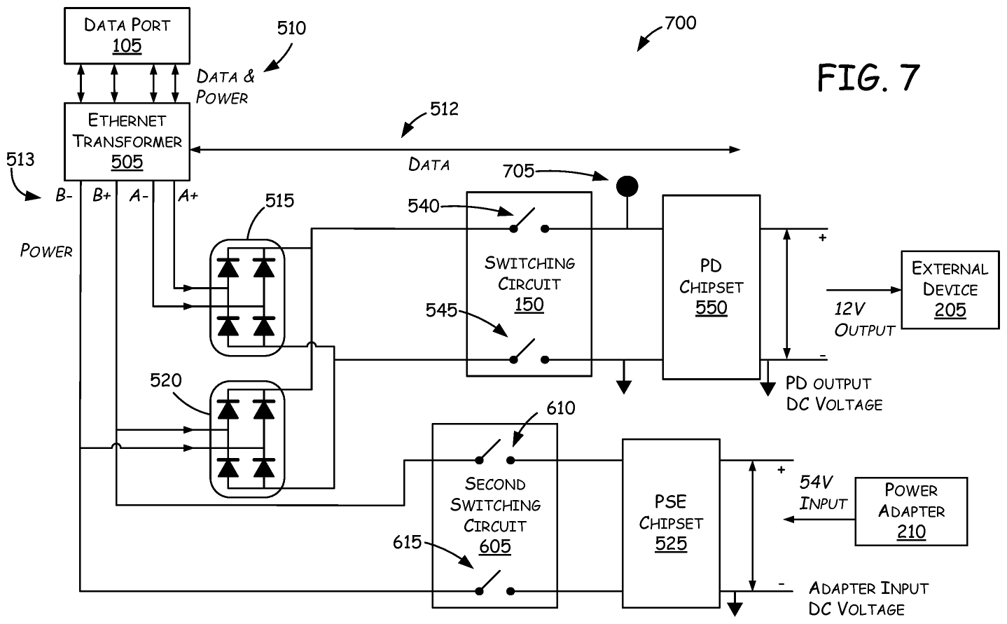

As illustrated in FIG. 1, in some configurations, the PD network 115 may include a switching circuit 150. The switching circuit 150 may one or more switches, including, e.g., a ground switch (i.e., a switch positioned along a ground line), a power switch (i.e., a switch positioned along a power line), or a combination thereof. The switching circuit 150 may control sourcing of power based on whether the switch(es) are opened or closed. As described in greater detail herein, the switching circuit 150 (or switch(es) included therein) may be opened or closed based on a source of the power, including, e.g., whether power is present or absent at the data port 105, the power jack 110, or a combination thereof. As illustrated in FIG. 1, the switching circuit 150 may be included as part of (or a component of) the PD network 115. Alternatively, or in addition, in some configurations, the PSE network 120 may include a switching circuit, as described in greater detail herein with respect to FIGS. 6-7.

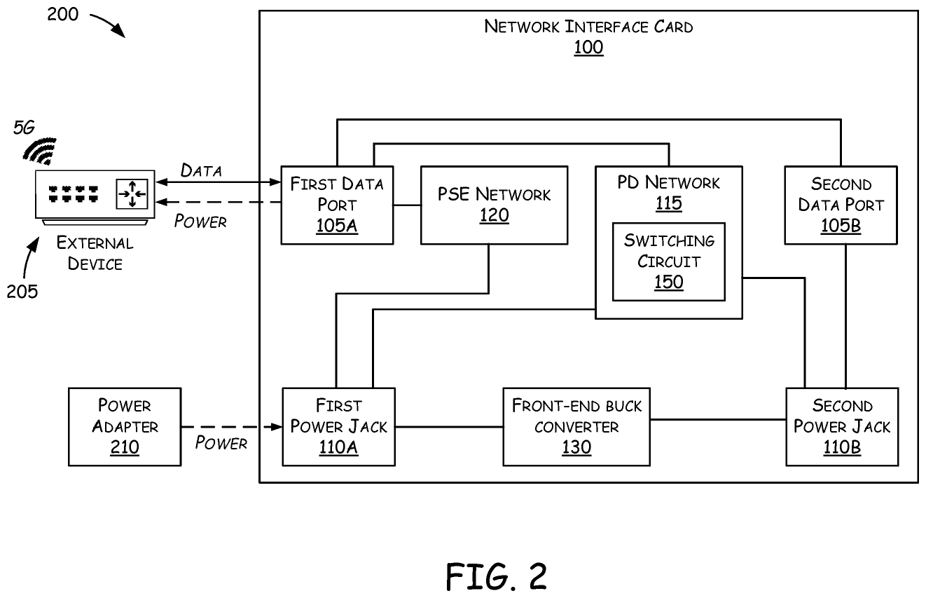

FIG. 2 illustrates an example configuration 200 in which an external device 205 and a power adapter 210 are electrically coupled to the NIC 100. As used herein, an external device may include any device external to the NIC 100 (e.g., not positioned or housed within the NIC 100). An external device may include, e.g., a network switch, a PoE Hub, a wireless access point (“WAP”), a voice over internet protocol (“VoIP”) phone, an internet protocol (“IP”) camera, an end device, a client device, a computing device, etc. In the example of FIG. 2, the external device 205 is a 5G wireless router (e.g., a WAP). In some configurations, an external power source, such as, e.g., the power adapter 210, may be considered an external device. The power adapter 210 may provide a power signal to the NIC 100. In some instances, the power signal may be a DC power signal (e.g., 54 V).

As illustrated in FIG. 2, the external device 205 may be electrically coupled to the NIC via a communication link established via the first data port 105A (e.g., an Ethernet cable electrically coupling the external device 205 to the first data port 105A). The power adapter 210 may be electrically coupled to the NIC 100 via a power connection established via the first power jack 110A (e.g., a power cord or cable electrically coupling the power adapter 210 to the first power jack 110A).

In the example configuration 200 of FIG. 2, the NIC 100 may function as PSE (e.g., in a PSE mode) and the external device 205 may be a PD. For instance, the NIC 100 may receive, via a first power jack 110A, a power signal from the power adapter 210 electrically coupled to the first power jack 110A (e.g., forming a first power connection). Responsive to power being present at the first power jack 110A, the switching circuit 150 (or switch(es) therein) may be opened. The NIC 100 may provide (or source), via the first data port 105A, the received power to the external device 205 (e.g., over a communication link established between the external device 205 and the NIC 100 via the first data port 105A). As also illustrated in the example configuration 200 of FIG. 2, the external device 205 and the NIC 100 may also exchange data via the communication link established via the first data port 105A.

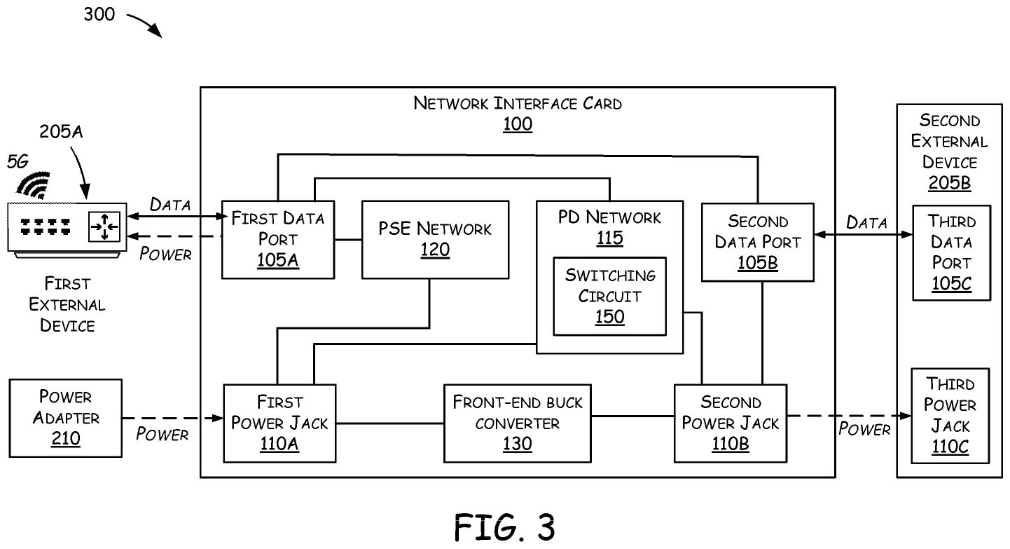

FIG. 3 illustrates another example configuration 300 in which a first external device 205A, a second external device 205B, and the power adapter 210 are electrically coupled to the NIC 100. While the configuration 300 of FIG. 3 is similar to the configuration 200 of FIG. 2 with respect to the first external device 205A (e.g., the external device 205 of FIG. 2) and the power adapter 210, the configuration 300 of FIG. 3 further includes an additional external device (e.g., the second external device 205B). As similarly described herein, the second external device 205B may be, e.g., a network switch, a PoE Hub, a WAP, a VoIP phone, an IP camera, an end device, a client device, a computing device, etc. As illustrated in the example of FIG. 3, the second external device 205B may include a third data port 105C (e.g., as similarly described herein with respect to the data port 105) and a third power jack 110C (e.g., as similarly described herein with respect to the power jack 110).

As illustrated in FIG. 3, the second external device 205B may be electrically coupled to the NIC 100 via a communication link established via a second data port 105B (e.g., an Ethernet cable electrically coupling the second external device 205B to the second data port 105B). Alternatively, or in addition, the second external device 205B may be electrically coupled to the NIC 100 via a power connection established via a second power jack 110B and the third power jack 110C (e.g., a power cord or cable electrically coupling the second power jack 110B to the third power jack 110C).

In the example configuration 300 of FIG. 3, the NIC 100 may function as PSE (e.g., in a PSE mode) and the first external device 205A and the second external device 205B may be PDs. For instance, the NIC 100 may receive, via the first power jack 110A, a power signal from the power adapter 210 electrically coupled to the first power jack 110A (e.g., forming a first power connection). The NIC 100 may provide (or source), via the first data port 105A, the received power to the first external device 205A (e.g., over a first communication link established between the first external device 205A and the NIC 100 via the first data port 105A), such as, e.g., by opening the switching circuit 150. Alternatively, or in addition, the NIC 100 may provide (or source), via the second power jack 110B, the received power to the second external device 205B (e.g., over a second power connection established between the second external device 205B and the NIC 100 via the second power jack 110B). As also illustrated in the example configuration 300 of FIG. 3, the first external device 205A and the NIC 100 may also exchange data via the first communication link established via the first data port 105A and the second external device 205B and the NIC 100 may exchange data via a second communication link established between the second external device 205B and the NIC 100 via the second data port 105B and the third data port 105C. In some configurations, the NIC 100 may forward the data received from the first external device 205A via the first data port 105A to the second external device 205B via the second data port 105B.

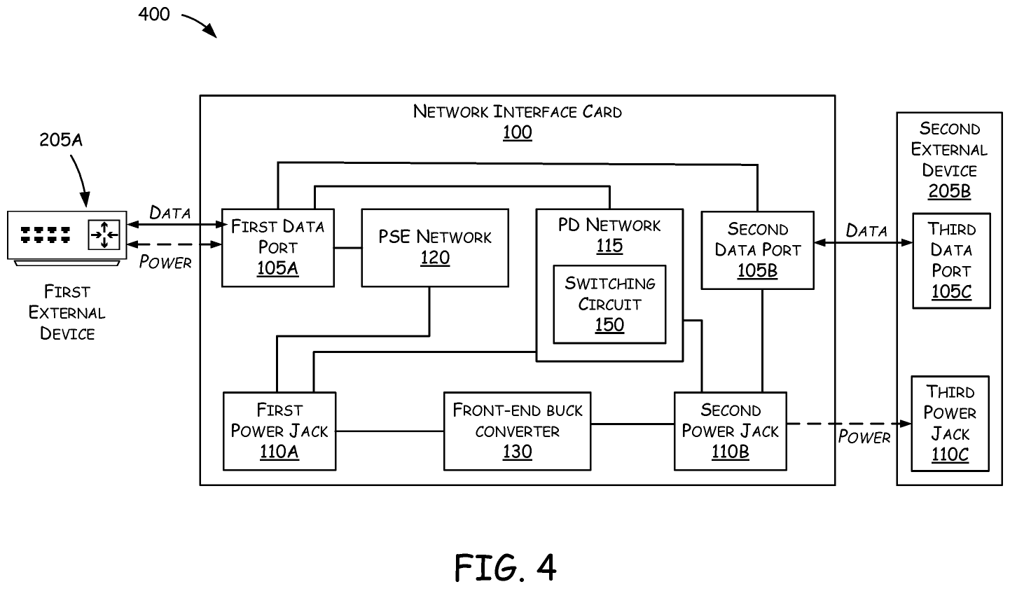

FIG. 4 illustrates another example configuration 400 in which the first external device 205A and the second external device 205B are electrically coupled to the NIC 100 (as similarly described herein with respect to the example configuration 300 of FIG. 3). While the configuration 400 of FIG. 4 is similar to the configuration 300 of FIG. 3 with respect to the first external device 205A and the second external device 205B, in the configuration 400 of FIG. 4 the power adapter 210 is no longer electrically coupled to the first power jack 110A.

In the example configuration 400 of FIG. 4, the first external device 205A may be a PoE Hub functioning as a PSE while the NIC 100 and the second external device 205B may function as PDs (e.g., in a PD mode). For instance, the NIC 100 may receive, via the first data port 105A, a set of signals, including, e.g., a data signal and a power signal, from the first external device 205A electrically coupled to first data port 105A (e.g., forming a first communication link). The first external device 205A may receive power (e.g., the power signal) from, e.g., another source (not illustrated). Responsive to power being present at the first data port 105A, the switching circuit 150 (or switch(es) therein) may be closed. The NIC 100 may provide (or source), via the second power jack 110B, the received power to the second external device 205B (e.g., over a second power connection established between the second external device 205B and the NIC 100 via the second power jack 110B and the third power jack 110C). As also illustrated in the example configuration 400 of FIG. 4, the first external device 205A and the NIC 100 may also exchange data via the first communication link established via the first data port 105A and the second external device 205B and the NIC 100 may exchange data via a second communication link established between the second external device 205B and the NIC 100 via the second data port 105B and the third data port 105C. In some configurations, the NIC 100 may forward the data received from the first external device 205A via the first data port 105A to the second external device 205B via the second data port 105B.

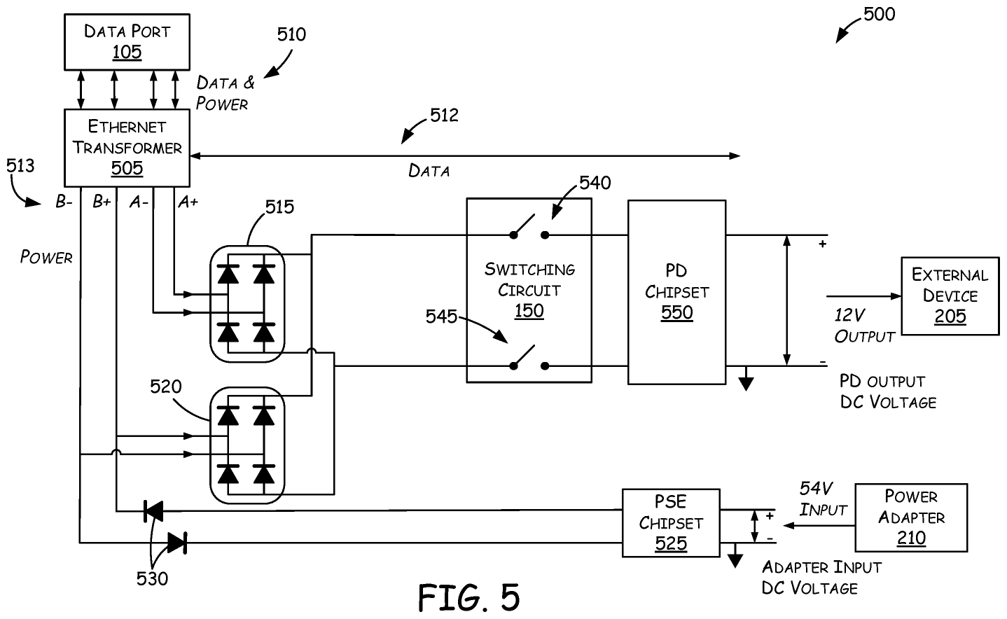

FIG. 5 schematically illustrates an example circuit diagram 500 of the NIC 100 in accordance with some configurations. As illustrated in FIG. 5, the circuit diagram 500 includes the data port 105 electrically coupled to an Ethernet transformer 505. The data port 105 and the Ethernet transformer 505 may exchange data signals, power signals, or a combination thereof (as represented in by reference numeral 510). As described herein, the Ethernet transformer 505 may split input signals into data signals and power signals. For instance, as illustrated in FIG. 5, the data port 105 may receive a set of signals including data signals and power signals. The set of signals may be provided to the Ethernet transformer 505 (represented in FIG. 5 by reference numeral 510). As illustrated in FIG. 5, data signals (represented in FIG. 5 by reference numeral 512) may be separated (or split) from the power signals (represented in FIG. 5 by reference numeral 513). In some instances, the data signals 512 may be transmitted to the external device 205 (e.g., the first external device 205A, the second external device 205B, etc.).

The Ethernet transformer 505 may be electrically coupled to a first diode bridge 515, a second diode bridge 520, and a PSE chipset 525. As illustrated in FIG. 5, in some instances, one or more diodes 530 may be positioned along the connection between the Ethernet transformer 505 and the PSE chipset 525. The PSE chipset 525 may be electrically coupled to a power jack, such as, e.g., the first power jack 110A, which may ultimately be electrically coupled to the power adapter 210. The PSE chipset 525 may also be electrically coupled to the second diode bridge 520. The first diode bridge 515 and the second diode bridge 520 may be electrically coupled to the switching circuit 150.

The PSE chipset 525 may merge or otherwise combine a power signal (e.g., a power signal received from the power adapter 210) with a data signal. The PSE chipset 525 may output the combined power and data signal for transmission via the Ethernet transformer 505 and data port 105.

As illustrated in FIG. 5, the first diode bridge 515 and the second diode bridge 520 may be bridge rectifiers. As illustrated in FIG. 5, the first diode bridge 515 may receive a power signal from the Ethernet transformer 505 via lines “A−” and “A+”. The first diode bridge 515 may filter out any reverse current associated with the received power signal and output the power signal to the switching circuit 150. The second diode bridge 520 may receive a power signal from the Ethernet transformer 505 via lines “B−” and “B+”. Alternatively, or in addition, the second diode bridge 520 may receive a power signal from the PSE chipset 525 (e.g., a power signal from the power adapter 210). Similar to the first diode bridge 515, the second diode bridge 520 may filter out any reverse current associated with the received power signal and output the DC power signal to the switching circuit 150.

As illustrated in FIG. 5, the switching circuit 150 may include a first switch 540 and a second switch 545. In the example illustrated, the first switch 540 may be positioned along a power line (as a power switch) and the second switch 545 may be positioned along a ground line (as a ground switch). Although FIG. 5 illustrates the switching circuit 150 including two switches (e.g., the first switch 540 and the second switch 545), the switching circuit 150 may include additional or fewer switches. For example, in some configurations, the switching circuit 150 may include a single switch positioned along either the ground line or the power line.

The switching circuit 150 may be electrically coupled to the PD chipset 550. The PD chipset 550 may be electrically coupled to a data port (e.g., the second data port 105B), a power jack (e.g., the second power jack 110B), or the like in order to output a power signal (e.g., a DC voltage signal) to, e.g., an external device (e.g., the external device 205). The PD chipset 550 may function as a voltage converter. For example, in some configurations, the PD chipset 550 may convert a first DC power signal (e.g., a DC power signal provided from the first diode bridge 515, the second diode bridge 520, or a combination thereof) to a second DC power signal, where that second DC power signal is less than the first DC power signal and is provided to an output power signal to, e.g., the external device 205 (including, e.g., the second external device 205B). Accordingly, in some instances, the PD chipset may be a step-down converter that receives power signal and steps that power signal down to a lower voltage. As one example, the PD chipset 550 may receive a 54 V power signal and convert the received 54 V power signal to a 12 V power signal, where the 12 V power signal is sourced to the external device 205.

As noted herein, the switching circuit 150 may control sourcing of power based on whether the first switch 540, the second switch 545, or a combination thereof are opened or closed. The first switch 540, the second switch 545, or a combination thereof may be opened or closed based on whether power is present at (or supply through) the data port 105 or the power adapter 210. For instance, when power is present at the PSE chipset 525 (e.g., supplied via the first power jack 110A from the power adapter 210), the switching circuit 150 may be opened. When the switching circuit 150 is open, power is sourced to the external device 205 from the power adapter 210 (e.g., through the second diode bridge 520). When power is absent at the PSE chipset 525 (e.g., not supplied via the first power jack 110A from the power adapter 210) and power is present at the data port 105, the switching circuit 150 may be closed. When the switching circuit 150 is closed, power is sourced to the external device 205 from the data port 105 (e.g., through the first diode bridge 515). When power is absent at both the PSE chipset 525 and the data port 105, the switching circuit 150 is open (e.g., as a default state).

FIG. 6 schematically illustrates another circuit diagram 600 of the NIC 100 in accordance with some configurations. The circuit diagram 600 of FIG. 6 is similar to the circuit diagram 500 of FIG. 5 with the exception that the one or more diodes 530 are replaced with a second switching circuit 605. As illustrated in FIG. 6, the second switching circuit 605 may be electrically coupled to the PSE chipset 525, the second diode bridge 520, and the ethernet transformer 505.

Similar to the switching circuit 150, the second switching circuit 605 may include one or more switches. In the example illustrated in FIG. 6, the second switching circuit 605 may include a first switch 610 and a second switch 615. As illustrated in FIG. 5, the switching circuit 150 may include a first switch 540 and a second switch 545. In the example illustrated, the first switch 610 may be positioned along a power line (as a power switch) and the second switch 615 may be positioned along a ground line (as a ground switch). Although FIG. 6 illustrates the second switching circuit 605 including two switches (e.g., the first switch 610 and the second switch 615), the second switching circuit 605 may include additional or fewer switches. For example, in some configurations, the second switching circuit 605 may include a single switch positioned along either the ground line or the power line.

The second switching circuit 605 may control sourcing of power based on whether the first switch 610, the second switch 615, or a combination thereof are opened or closed. The first switch 610, the second switch 615, or a combination thereof may be opened or closed based on whether power is present at the PSE chipset 525 (or supply from) the power adapter 210. For instance, when power is present at the PSE chipset 525 (e.g., supplied via the first power jack 110A from the power adapter 210), the second switching circuit 605 may be closed. When power is absent at the PSE chipset 525 (e.g., not supplied via the first power jack 110A from the power adapter 210), the second switching circuit 605 may be opened.

In some configurations, the second switching circuit 605, the first switching circuit 150, or a combination thereof may control sourcing of power. For example, in some configurations, when power is present at the first power jack 110A, the switching circuit 150 is open and the second switching circuit 605 is closed; when power is absent at the first power jack 110A and power is present at the first data port 105A, the switching circuit 150 is closed and the second switching circuit 605 is open; and when power is absent at the first power jack 110A and power is absent at the first data port 105A, the switching circuit 150 is open and the second switching circuit 605 is open.

FIG. 7 schematically illustrates yet another circuit diagram 700 of the NIC 100 in accordance with some configurations. The circuit diagram 700 of FIG. 7 is similar to the circuit diagram 600 of FIG. 6 with the addition of a power connection 705 electrically connected between the switching circuit 150 and the PD chipset 550. The power connection 705 may enable power supplied from the power adapter 210 via the second power jack 110B to be sourced to the PD chipset 550. Accordingly, in some configurations, power supplied via the power adapter 210 (e.g., at the second power jack 110B) may be routed directly to the PD chipset 550 via the power connection 705.

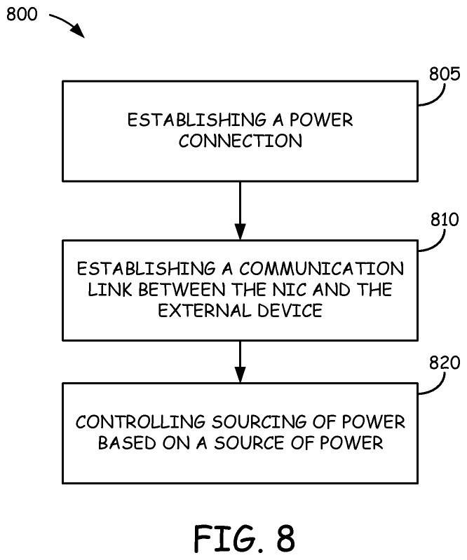

FIG. 8 is a flow chart illustrating a method 800 of implementing PoE using the NIC 100 in accordance with some configurations. As illustrated in FIG. 8, the method 800 may include establishing a power connection (at block 805). The power connection may be established between the NIC 100 and the power adapter 210. The power connection may be established by coupling the power adapter 210 to the power jack 110 (e.g., the first power jack 110A) of the NIC 100. The power connection may enable the exchange of power between the NIC 100 and the power adapter 210. For example, the power adapter 210 may supply a 54 volt power signal to the NIC 100.

The method 800 may include establishing a communication link between the NIC 100 and the external device 205 (at block 810). As one example, the communication link may be established between the NIC 100 and the first external device 205A, as illustrated in FIGS. 2-4. The communication link may be established between the NIC 100 and the external device 205 by coupling an Ethernet cable to the data port 105 (e.g., the first data port 105A), where the Ethernet cable is also coupled to a data port of the external device 205. Accordingly, in some configurations, the communication link may enable the exchange of data and sourcing of power between the NIC 100 and the external device 205.

In some configurations, the method 800 may include controlling sourcing of power based on a source of power (at block 820). In some configurations, sourcing of power may be controlled via the switching circuit 150, the second switching circuit 605, or a combination thereof. For example, in some configurations, controlling the sourcing of power may include opening the switching circuit 150 (or switch(es) therein) responsive to power being received at the power jack 110 (e.g., the first power jack 110A). Alternatively, or in addition, in some configurations, controlling the sourcing of power may include closing the switching circuit 150 (or switch(es) therein) responsive to power being received at the data port 105 (e.g., the first data port 105A). In some configurations, opening the switching circuit 150 responsive to power being received at the first power jack may inhibit the power being received at the first power jack 110A from flowing to the PD chipset 550 of the NIC 100. In some configurations, closing the switching circuit 150 responsive to power being received at the first data port 105A may enable the power being received at the first data port 105A to flow to the PD chipset 550 of the NIC 100.

In some configurations, the method 800 may include establishing a power connection between the NIC 100 and the second external device 205B (as a second power connection). The second power connection may be established between the NIC 100 to the second external device 205B by coupling the second power jack 110B to a power jack of the second external device 205B (e.g., the third power jack 110C of FIGS. 3-4). Alternatively, or in addition, in some configurations, the method 800 may include establishing a communication link between the NIC 100 and the second external device 205B (as a second communication link). The second communication link may be established between the NIC 100 and the second external device 205B by coupling an Ethernet cable or other cable to the second data port 105B and a data port of the second external device 205B (e.g., the third data port 105C of FIGS. 3-4).

In some configurations, the method 800 may include receiving, at the first data port 105A of the NIC 100, a set of signals from the first external device 205A, where the set of signals may include a power signal and a data signal. The method 800 may include splitting, via an Ethernet transformer associated with the first data port 105A (e.g., the Ethernet transformer 505) the set of signals into the power signal and the data signal. The method 800 may then include transmitting, via the second power jack 110B of the NIC 100, the power signal(s) to the second external device 205B and transmitting, via the second data port 105B of the NIC 100, the data signal(s) to the second external device 205B.

In some configurations, the method 800 may include receiving, at the first power jack 110A of the NIC 100, a first power signal from the power adapter 210, where the first power signal may be a DC power signal. The method 800 may include merging, with the PSE chipset 525 included in the NIC 100, the DC power signal with a data signal (as a combined power-data signal). The method 800 may then include transmitting, via the first data port 105A of the NIC 100, the combined power-data signal to the first external device 205A.

In some examples, aspects of the technology, including computerized implementations of methods according to the technology, can be implemented as a system, method, apparatus, or article of manufacture using standard programming or engineering techniques to produce software, firmware, hardware, or any combination thereof to control a processor device (e.g., a serial or parallel general purpose or specialized processor chip, a single- or multi-core chip, a microprocessor, a field programmable gate array, any variety of combinations of a control unit, arithmetic logic unit, and processor register, and so on), a computer (e.g., a processor device operatively coupled to a memory), or another electronically operated controller to implement aspects detailed herein. Accordingly, for example, examples of the technology can be implemented as a set of instructions, tangibly embodied on a non-transitory computer-readable media, such that a processor device can implement the instructions based upon reading the instructions from the computer-readable media. Some examples of the technology can include (or utilize) a control device such as an automation device, a special purpose or general-purpose computer including various computer hardware, software, firmware, and so on, consistent with the discussion below. As specific examples, a control device can include a processor, a microcontroller, a field-programmable gate array, a programmable logic controller, logic gates etc., and other typical components that are known in the art for implementation of appropriate functionality (e.g., memory, communication systems, power sources, user interfaces and other inputs, etc.).

Certain operations of methods according to the technology, or of systems executing those methods, can be represented schematically in the FIGS. or otherwise discussed herein. Unless otherwise specified or limited, representation in the FIGS. of particular operations in particular spatial order can not necessarily require those operations to be executed in a particular sequence corresponding to the particular spatial order. Correspondingly, certain operations represented in the FIGS., or otherwise disclosed herein, can be executed in different orders than are expressly illustrated or described, as appropriate for particular examples of the technology. Further, in some examples, certain operations can be executed in parallel, including by dedicated parallel processing devices, or separate computing devices configured to interoperate as part of a large system.

As used herein in the context of computer implementation, unless otherwise specified or limited, the terms “component,” “system,” “module,” “block,” and the like are intended to encompass part or all of computer-related systems that include hardware, software, a combination of hardware and software, or software in execution. For example, a component can be, but is not limited to being, a processor device, a process being executed (or executable) by a processor device, an object, an executable, a thread of execution, a computer program, or a computer. By way of illustration, both an application running on a computer and the computer can be a component. One or more components (or system, module, and so on) can reside within a process or thread of execution, can be localized on one computer, can be distributed between two or more computers or other processor devices, or can be included within another component (or system, module, and so on).

Also as used herein, unless otherwise limited or defined, “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as “either,” “one of,” “only one of,” or “exactly one of” Further, a list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more of each of A, B, and C. Similarly, a list preceded by “a plurality of” (and variations thereon) and including “or” to separate listed elements indicates options of multiple instances of any or all of the listed elements. For example, the phrases “a plurality of A, B, or C” and “two or more of A, B, or C” indicate options of: A and B; B and C; A and C; and A, B, and C. In general, the term “or” as used herein only indicates exclusive alternatives (e.g., “one or the other but not both”) when preceded by terms of exclusivity, such as “either,” “one of,” “only one of,” or “exactly one of.”

As used herein, “PoE” may include various versions or implementations of PoE, including, e.g., PoE+, PoE++, etc.

Although the present technology has been described by referring to preferred examples, workers skilled in the art will recognize that changes can be made in form and detail without departing from the scope of the discussion.

What is claimed is:

1. A system for providing power over Ethernet (PoE), comprising:
a network interface card (“NIC”) including:
a first power jack configured to establish a first power connection with a power adapter;
a first data port configured to establish a first communication link between the NIC and a first external device, wherein the first communication link enables an exchange of data and sourcing of power with the first external device;
a second data port configured to establish a second communication link between the NIC and a second external device, wherein the second communication link enables an exchange of data with the second external device;
a second power jack configured to establish a second power connection between the NIC and the second external device, wherein the second power jack is configured to provide power to the second external device; and
a first switching circuit communicatively coupled to the first data port and the second power jack, wherein the first switching circuit includes a first switch and is configured to control sourcing of power to the second external device by opening or closing the first switch based on a source of the power, wherein the first switch is closed responsive to power received at the first data port, and wherein the first switch is opened responsive to power received at the first power jack.

2. The system of claim 1,
wherein, when the first switch included in the first switching circuit is closed, power is sourced to the second external device via the second power jack; and
wherein, when the first switch included in the first switching circuit is open, power is sourced to the first external device via the first data port.

3. The system of claim 1, wherein the NIC is coupled directly to the first external device and the second external device, wherein the NIC facilitates the exchange of data and the sourcing of power between the first external device and the second external device.

4. The system of claim 1, wherein the first switch is a ground switch or a power switch.

5. The system of claim 1, wherein the first switching circuit includes a second switch, wherein the first switch is a ground switch and the second switch is a power switch.

6. The system of claim 1, wherein the first external device operates as power sourcing equipment (“PSE”) and the second external device operates as a powered device (“PD”), wherein the NIC is configured to receive power from the first external device and source the power to the second external device.

7. The system of claim 1, wherein the first external device operates as a PD and the NIC operates as PSE, wherein the NIC is configured to receive power from the power adapter and source the power to the first external device.

8. The system of claim 1, wherein the first external device operates as PSE and the NIC operates as a PD, wherein the NIC is configured to receive power from the first external device and source the power to the second external device.

9. The system of claim 1, wherein the NIC further includes:
a PSE chipset configured to merge a first DC power signal and a data signal; and
a PD chipset including a DC-to-DC converter configured to convert the power from a second DC power signal to a third DC power signal, wherein the second DC power signal is greater than the third DC power signal.

10. The system of claim 9, wherein the PSE chipset is configured to receive the first DC power signal from the first power jack, merge the first DC power signal with the data signal as a combined power-data signal, and source the combined power-data signal to the first external device via the first data port, and wherein the PD chipset is configured to receive the second DC power signal from the first data port and source the third DC power signal to the second external device via the second power jack.

11. The system of claim 1, wherein the NIC further includes:
a second switching circuit including a second switch switchable between an open state and a closed state based on whether power is present at the first power jack, wherein the first switching circuit and the second switching circuit are configured to control sourcing of power based on the source of power, and wherein,
when power is present at the first power jack, the first switch is open and the second switch is closed;
when power is absent at the first power jack and power is present at the first data port, the first switch is closed and the second switch is open; and
when power is absent at the first power jack and power is absent at the first data port, the first switch is open and the second switch is open.

12. The system of claim 1, wherein the first data port is associated with a first Ethernet transformer, wherein the first Ethernet transformer is configured to separate data signals and power signals received at the first data port.

13. A network interface card (NIC) for providing power over Ethernet (PoE), the NIC comprising:
a first power jack configured to establish a first power connection with a power adapter;
a first data port configured to establish a first communication link between the NIC and a first external device, wherein the first communication link enables an exchange of data and sourcing of power;
a second data port configured to establish a second communication link between the NIC and a second external device, wherein the second communication link enables exchange of data with the second external device;
a second power jack configured to establish a second power connection between the NIC and the second external device, wherein the second power jack is configured to provide power to the second external device;
a power sourcing equipment (PSE) chipset configured to merge data and power signals;
a powered device (PD) chipset configured to convert power received at the first power jack from a first DC power signal to a second DC power signal, wherein the first DC power signal is greater than the second DC power signal; and
a first switching circuit configured to control sourcing of power, and
wherein, when the first power jack receives power, a first switch of the first switching circuit is opened, and
wherein, when the first data port receives power, the first switch of the first switching circuit is closed to source the power received at the first data port to the second external device.

14. The NIC of claim 13, further comprising:
a second switching circuit including a second switch switchable between an open state and a closed state based on whether power is present at the first power jack, wherein
when power is present at the first power jack, the first switch is open and the second switch is closed;
when power is absent at the first power jack and power is present at the first data port, the first switch is closed and the second switch is open; and
when power is absent at the first power jack and power is absent at the first data port, the first switch is open and the second switch is open.

15. The NIC of claim 13, wherein the NIC is configured to operate in a PSE mode or a PD mode.

16. The NIC of claim 15, wherein when the NIC operates in a PSE mode, power and data signals are merged via the PSE chipset and when the NIC operates in the PD mode, power is converted via the PD chipset.

17. A method for providing power over Ethernet (PoE), the method comprising:
establishing, via a first power jack of a network interface card (“NIC”), a first power connection with a power adapter;
establishing, via a first data port of the NIC, a first communication link between the NIC and a first external device, wherein the first communication link enables an exchange of data and sourcing of power; and
controlling, via a first switching circuit of the NIC, sourcing of power based on a source of power by:
opening a first switch included in the first switching circuit responsive to power being received at the first power jack to inhibit the power being received at the first power jack from flowing to a PD chipset of the NIC; and
closing the first switch included in the first switching circuit responsive to power being received at the first data port to enable the power being received at the first data port to flow to the PD chipset of the NIC.

18. The method of claim 17, further comprising:
establishing, via a second power jack of the NIC, a second power connection between the NIC and a second external device; and
establishing, via a second data port of the NIC, a second communication link between the NIC and the second external device.

19. The method of claim 18, further comprising:
receiving, at the first data port of the NIC, a set of signals from the first external device, the set of signals including a power signal and a data signal;
splitting, via a transformer associated with the first data port, the set of signals into the power signal and the data signal;
transmitting, via the second power jack of the NIC, the power signal to the second external device; and
transmitting, via the second data port of the NIC, the data signal to the second external device.

20. The method of claim 17, further comprising:
receiving, at the first power jack of the NIC, a first power signal from a power adapter;
merging, with a power sourcing equipment (PSE) chipset included in the NIC, the first power signal with a data signal as a combined power-data signal; and
transmitting, via the first data port of the NIC, the combined power-data signal to the first external device.
